(19) United States
(12) Patent Application Publication
(10) Pub. No.: US 2011/0089651 A1
(43) Pub. Date: Apr. 21, 2011

(54) SYSTEM FOR TRANSPORTING GOODS

(76) Inventor: Leda Carmen DE BESSA CAMARGO E ANDRADE, Santa Helena (BR)

(21) Appl. No.: 12/843,526

(22) Filed: Jul. 26, 2010

(30) Foreign Application Priority Data
Oct. 16, 2009 (BR) PI0904000-5

(51) Int. Cl. B62B 3/14

(52) U.S. Cl. 280/33.992

(57) ABSTRACT

A “SYSTEM FOR TRANSPORTING GOODS” comprising a structure (1) provided with wheels (2), support columns (3), “U” profiles fitted on the side walls of the cart structure, for placing and transporting a single deep basket (5) with goods purchased at, e.g. supermarkets, for subsequently transferring said basket (5) full of goods directly to a structure (6) with “U” profiles which have previously been fitted inside a motor car trunk.

Said basket (5) comprises side flaps (7) so that it may be placed and supported on the sides of the structure fitted in the supermarket cart (1), wherein the front portion of the cart is provided with jointed sheets (8) with joints (9) on one side so as to allow a perfect fitting of the basket by its side flaps (7) which fit into the side grooves (4), in such a way that the height for placing the basket may be regulated depending on the position of the “U” profiles placed on the cart sides, thus facilitating withdrawal of the basket from the cart and handling by the user.

This patent of invention disclosure refers to a novel system for transporting goods, to wit, a means of transport used for carrying goods purchased, e.g. at supermarkets, comprising a structure similar to a supermarket cart with pairs of profiles fitted in a motor vehicle trunk, allowing for placing and removing thereof, with a novel conception and provided with functional improvements following modern concepts and according to required standards and specifications, comprising specific features and the essential requirements of novelty and inventive activity, thus resulting in a series of actual and extraordinary technical, practical and economic advantages.

Currently supermarket carts are well known, comprising various models which feature a metal structure supported on wheels which allow for placement of goods in the interior thereof. Said carts for transporting goods are considered to be one of the most important tools for supermarkets, since purchasing is aided by storing and then transferring the goods to bags or boxes.

As is well known to experts in this matter, such supermarket carts are composed, as a rule, of a metallic structure body comprising a bar for cart support and control, and a storage basket which allows for purchased goods to be placed within.

### BACKGROUND ART

U.S. Pat. No. 4,116,456 patent entitled “SHOPPING CART”, dated Sep. 26, 1978 discloses a top extended basket with a bottom for carrying groceries and similar goods, a couple of spaced extended side walls, a fixed rear end wall reaching above the bottom at a sufficient height, and placed between the side walls.

The object of patent document U.S. Pat. No. 4,610,454 dated Sep. 9, 1986 entitled “SHOPPING CART” discloses a shopping cart for groceries wherein the bottom part thereof has an adapted feature which fits in the cart basket, as a precedent, which in the bottom portion is transversely spaced in order to define a space on the bottom portion of the cart below the basket, also comprising a platform, a bar fixed to the platform finishing on the opposite side of the platform, and a square with features which are adapted to support the platform.

Patent Document U.S. Pat. No. 6,676,139 entitled “SHOPPING CART” dated Jan. 13, 2004 discloses a shopping cart comprising a framework, and a basket mounted on the framework so that the whole basket moves in connection to the framework when a load is placed within the basket.

Domestic patent document MU8102214-0, filed on Oct. 5, 2001, entitled “ARRANGEMENT INTRODUCED IN A SUPERMARKET CART”, discloses the fixing of two panels; one on the front inner portion and the other one on the outer front face of supermarket carts; said panels being made of metal sheet or not, preferably with the front shape of a supermarket cart, but with any possible geometric shape even forming outlines of articles or things.

Likewise, patent document MU8701893-4 entitled ARRANGEMENT INTRODUCED IN A SUPERMARKET CART dated Oct. 5, 2007 discloses a supermarket cart model so as to optimize storage and transport thereof from the factory to the retailer or wholesale store, composed of a chassis with slotted-in wheels, wherein a pair of back wheels is placed on supports and a revolving front pair of wheels is placed on a regular support.

Said background art is all included since they possess boxes for storage of goods, which goods must be, after being stored, subsequently removed from the carts and stored in other boxes or bags, as these supermarket carts may not be stocked within, e.g. motor car trunks due to the size of the constructive arrangement thereof, unlike the object of this patent.

In view thereof, several studies have been conducted with the aim of doing away with all the mentioned issues and therefore, this system was conceived, which enables the creation of a novel system for transporting goods, usually employed in supermarkets, through which the possibility of placing an independent basket on the structure of these carts was devised, thus enabling users to remove the basket when he/she has finished using the cart and transferring the goods directly in the basket to the structure fitted in the inside of the motor car trunk, thus optimizing the use of boxes and bags and hence preserving the environment through sustainable use and development. Therefore, an integrated system is obtained, with actual chances of being manufactured with minimized costs, assembly time and labor expenses, as well as featuring improved results and a high safety pattern.

Thus, the object of this patent of invention is to provide a novel system for transporting goods using a supermarket cart; placing a basket in the cart which may be placed and removed by the user so that when he/she has finished storing the goods inside the basket he/she may transfer them to his/her car thus avoiding use of boxes and plastic bags and cooperating with conscious consumption and sustainable use of the environment.

These and other aims are included in a constructive arrangement comprising a structure provided with wheels, support columns, “U” profiles fixed on the side walls of the cart structure for fitting and transporting a basket with goods purchased at, e.g., supermarkets, for then transferring the basket full of goods directly to a structure with “U” profiles which has been previously fitted into the motor vehicle trunk.

Said basket, a single deep basket, comprises side flaps so that it may be placed and supported on the sides of the structure fitted on the supermarket cart, wherein the front part of the cart is provided with jointed sheets on one of the sides so as to enable a perfect fitting of the basket by its side flaps which fit into the side grooves, so that the height for fitting the basket may be regulated depending on the position of the “U” profiles placed on the cart sides, in order to facilitate the withdrawal from the cart and handling thereof by the user.

In order to add to this description and enable a better understanding of the features of this patent, and according to a preferred practical embodiment thereof, a set of figures is attached hereto wherein the following is featured, by way of example but not with the aim of limiting the same:

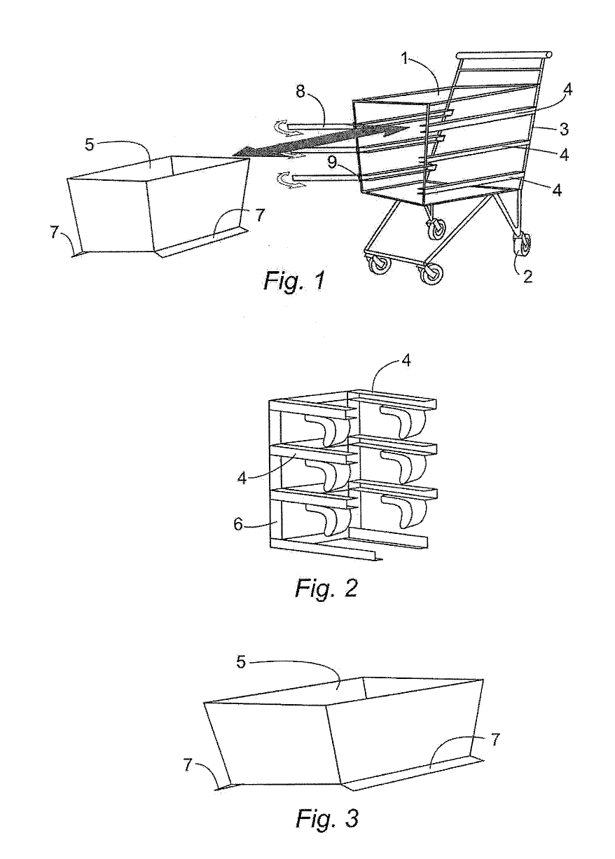

FIG. 1 shows a perspective view of the structure of the system for transporting goods used within the supermarket, and from the cash register to the motor vehicle;

FIG. 2 shows a perspective view of the structure of the system for transporting goods used within the motor vehicle trunk;

FIG. 3 shows a perspective view of the structure of the basket for transporting goods;

According to the above figures and their descriptions, this patent comprises a constructive arrangement comprising a structure (1) provided with wheels (2), support columns (3), “U” profiles (4) fitted on the side walls of the cart structure, for placing and transporting a single deep basket (5), with goods purchased, e.g. in supermarkets, so that subsequently the same basket (5) full of goods may be directly transferred to a structure (6) with “U” profiles previously fitted in the interior of a motor car trunk.

Said basket (5) comprises side flaps (7) so that it may be placed and supported on the sides of the structure fitted within the supermarket cart (1), wherein the front portion of the cart is provided with jointed sheets (8) with joints (9) on one of the sides thereof so as to allow a perfect placement of the basket by its side flaps (7) which fit into the side grooves (4), so that the height for placing the basket may be regulated depending on the position of the “U” profiles fitted on the cart sides, and thus facilitating their removal from the cart and handling thereof by the user.

There is no knowledge of any system for transporting goods which includes all the above mentioned constructive and functional features and which directly or indirectly was or is as effective as the object of this patent.

Having described and illustrated this invention, and in order to understand that the same may be subject to several changes and variations in its embodiments, as long as such changes are not removed from the spirit and scope of the invention, it is defined in the attached claims.

1- A SYSTEM FOR TRANSPORTING GOODS, which is composed of a structure (1) provided with wheels (2), support columns (3), “U” profiles (4) placed on the side walls of the cart structure for placing and transporting a single deep basket (5) for storing goods purchased at, e.g. supermarkets, for subsequently transferring said basket (5) full of goods directly to a structure (6) with “U” profiles which has been previously fitted inside a motor car trunk;

2- A SYSTEM FOR TRANSPORTING GOODS wherein said basket (5) features side flaps (7) so that the same may be placed and supported on the side walls of a structure fitted in the supermarket cart (1), wherein the front part of the cart is provided with jointed sheets (8) with joints (9) on one of their sides so as to allow a perfect fixing of the basket by its side flaps (7) which fit into the side grooves (4), so that the height for placing the basket depends on the position of the “U” profiles featured on the cart sides.
